(19) United States
(12) Patent Application Publication
(10) Pub. No.: US 2008/0011333 A1
(43) Pub. Date: Jan. 17, 2008

(54) Cleaning coating dispensers

(76) Inventors: Michael C. Rodgers, Montpelier, OH (US); David M. Seitz, Riga, MI (US)

Correspondence Address: BARNES & THORNBURG LLP, 11 SOUTH MERIDIAN, INDIANAPOLIS, IN, 46204, US

(21) Appl. No.: 11/485,935

(22) Filed: Jul. 13, 2006

(51) Int. Cl. B08B 3/00

(52) U.S. Cl. 134/94.1

(57) ABSTRACT

Apparatus for cleaning an atomizer includes a cleaning device including an opening sized to receive at least a portion of the atomizer. The cleaning device includes a solvent coupling for supplying solvent to wash an exterior surface of the atomizer and an opening through which waste solvent is discharged. A first conduit is formed in a first closed curve around the opening. The first conduit includes a first sidewall. A supply of drying gas or mixture of gases is coupled to the first conduit. At least a first passageway is provided through the first sidewall. An outer end of the or each first passageway directs a first flow of drying gas or mixture of gases onto the exterior surface of the atomizer to dry the exterior surface of the atomizer as the atomizer is withdrawn from the opening.

### FIELD OF THE INVENTION

This invention relates to coating material dispensing apparatus. It is disclosed in the context of apparatus for cleaning outside surfaces of coating dispensing apparatus, but is believed to be useful in other applications as well.

### BACKGROUND OF THE INVENTION

Methods and apparatus employing robotic devices for dispensing various types of coating materials are known. There are, for example, the methods and apparatus illustrated and described in the following U.S. patents and published U.S. patent applications: U.S. Pat. Nos. 7,018,679; 7,014,713; 7,005,159; 6,997,992; 6,991,683; 6,989,176; 6,986,366; 6,972,052; 6,959,884; 6,955,724; 6,946,032; 6,945,483; 6,945,470; 6,942,161; 6,935,366; 6,929,698; 6,924,005; 6,908,048; 6,899,279; 6,896,010; 6,892,963; 6,892,764; 6,877,681; 6,874,712; 6,835,248; 6,817,555; 6,817,553; 6,802,463; 6,777,032; 6,757,586; 6,756,080; 6,751,520; RE38,526; 6,722,591; 6,712,291; 6,712,285; 6,703,079; 6,702,893; 6,685,106; 6,682,001; 6,679,193; 6,672,521; 6,666,164; 6,663,021; 6,656,276; 6,651,902; 6,630,025; 6,627,266; 6,612,345; 6,589,342; 6,582,766; 6,569,258; 6,554,212; 6,511,712; 6,506,454; 6,460,787; 6,458,424; 6,457,655; 6,443,371; 6,439,480; 5,759,271; D459,260; 6,398,871; 4,984,745; 4,798,341; 4,679,734; 4,561,592; 4,196,465; 2006/0048803; 2006/0068117; and, 2006/0068109. The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

As used in this application, terms such as “electrically conductive” and “electrically non-insulative” refer to a broad range of conductivities electrically more conductive than materials described as “electrically non-conductive” and “electrically insulative.” Terms such as “electrically semiconductive” refer to a broad range of conductivities between electrically conductive and electrically non-conductive.

When dispensing coatings with an atomizing device, overspray mist can accumulate on exterior surfaces of the atomizing device. Over time, this buildup may accumulate sufficiently that it sloughs off and contacts the surface being coated (hereinafter sometimes the target). The sloughed off accumulation can cause a defect in the coating on the target, requiring time-consuming and costly repair of the coating.

In order to reduce the potential for these defects, dispensing devices are routinely cleaned, either manually or automatically. When a dispensing device is manually cleaned, the operator visually inspects the exposed surfaces of the dispensing device for areas of contamination, cleans the contaminated areas and dries them thoroughly. This is particularly important if high-magnitude electrostatic potential is used in the atomization and dispensing process. For waterborne coating material applications in particular, drying of these surfaces is critical, since the dispensing devices are cleaned with water, which is electrically relatively non-insulative. Moisture left on these surfaces tends to attract additional overspray. Several automated devices have been proposed to clean these surfaces, but these proposed automated devices generally lack the ability to dry these surfaces thoroughly.

### DISCLOSURE OF THE INVENTION

According to an aspect of the invention, apparatus for cleaning an atomizer comprises a cleaning device including an opening sized to receive at least a portion of the atomizer. The cleaning device includes a solvent coupling for supplying solvent to wash an exterior surface of the atomizer and an opening through which waste solvent is discharged. A first conduit formed in a first closed curve around the opening includes a first sidewall. A coupler is provided for coupling a supply of drying gas or mixture of gases to the first conduit. At least a first passageway is provided through the first sidewall. An outer end of each first passageway directs a first flow of drying gas or mixture of gases onto the exterior surface of the atomizer to dry the exterior surface of the atomizer as the atomizer is withdrawn from the opening.

Illustratively according to this aspect of the invention, the first passageways are so oriented that adjacent first flows overlap or intersect each other to form a first curtain of drying gas or mixture of gases.

Illustratively according to this aspect of the invention, the first flows make angles θ with lines drawn from a front of the atomizer, 90°≦θ≦180°.

Illustratively according to this aspect of the invention, the first passageways comprise at least one first slot. Long dimensions of the at least one first slot extend generally along the first closed curve.

Illustratively according to this aspect of the invention, the first passageways have first circular cross sections. The axes of the first passageways make the angles θ.

Further illustratively according to this aspect of the invention, the apparatus includes a second conduit formed in a second closed curve around the opening. The second conduit includes a second sidewall. A supply of drying gas or mixture of gases is coupled to the second conduit. At least one second passageway is provided through the second sidewall. An outer end of each second passageway directs a second flow of drying gas or mixture of gases onto the exterior surface of the atomizer to dry the exterior surface of the atomizer as the atomizer is withdrawn from the opening.

Illustratively according to this aspect of the invention, the second flows of drying gas or mixture of gases make angles φ with lines drawn from a front of the atomizer, 90°≦φ≦180°.

Illustratively according to this aspect of the invention, the second passageways comprise at least one second slot, the long dimension of the at least one second slot extending generally along the second closed curve.

Illustratively according to this aspect of the invention, the second passageways have second circular cross sections. The axes of the second passageways make the angles φ.

Further illustratively according to this aspect of the invention, the apparatus includes a robot for manipulating the atomizer into and from the opening.

Further illustratively according to this aspect of the invention, the apparatus includes a coating booth in which the coating is dispensed. The cleaning device is located inside the coating booth.

Illustratively according to this aspect of the invention, the cleaning device is coupled to the coating booth floor. The coating booth floor provides vacuum for extracting the solvent from the cleaning device.

### BRIEF DESCRIPTION OF THE DRAWINGS

The invention may best be understood by referring to the following detailed descriptions and accompanying drawings. In the drawings:

FIG. 1 illustrates a diagrammatic end elevational view of an installation useful in understanding the invention;

FIG. 2 illustrates a fragmentary end elevational view of a detail of the apparatus illustrated in FIG. 1, with a component of the apparatus in a cleaning orientation;

FIG. 3 illustrates a partly diagrammatic elevational view of the detail illustrated in FIG. 2, illustrating certain characteristics thereof;

FIG. 4 illustrates a top plan view of the apparatus illustrated in FIG. 3;

FIG. 5 illustrates a perspective view of a detail of the apparatus illustrated in FIGS. 3-4;

FIG. 6 illustrates an enlarged view of details of the apparatus illustrated in FIGS. 3-5;

FIG. 7 illustrates a partly diagrammatic elevational view of the detail illustrated in FIG. 2, illustrating certain characteristics thereof;

FIG. 8 illustrates a top plan view of an alternative detail of the apparatus illustrated in FIGS. 3-6; and,

FIG. 9 illustrates a sectional side elevational view of the apparatus illustrated in FIG. 8, taken generally along section lines 9-9 of FIG. 8;

FIG. 10 illustrates a top plan view of another embodiment of the apparatus of the invention;

FIG. 11 illustrates a perspective view of a detail of the apparatus illustrated in FIG. 10;

FIG. 12 illustrates a side elevational view of the detail illustrated in FIG. 11;

FIG. 13 illustrates a top plan view of another embodiment of the apparatus of the invention;

FIG. 14 illustrates a perspective view of a detail of the apparatus illustrated in FIG. 13; and,

FIG. 15 illustrates a sectional view of the detail illustrated in FIG. 14, taken generally along section lines 15-15 of FIGS. 13-14.

### DETAILED DESCRIPTIONS OF ILLUSTRATIVE EMBODIMENTS

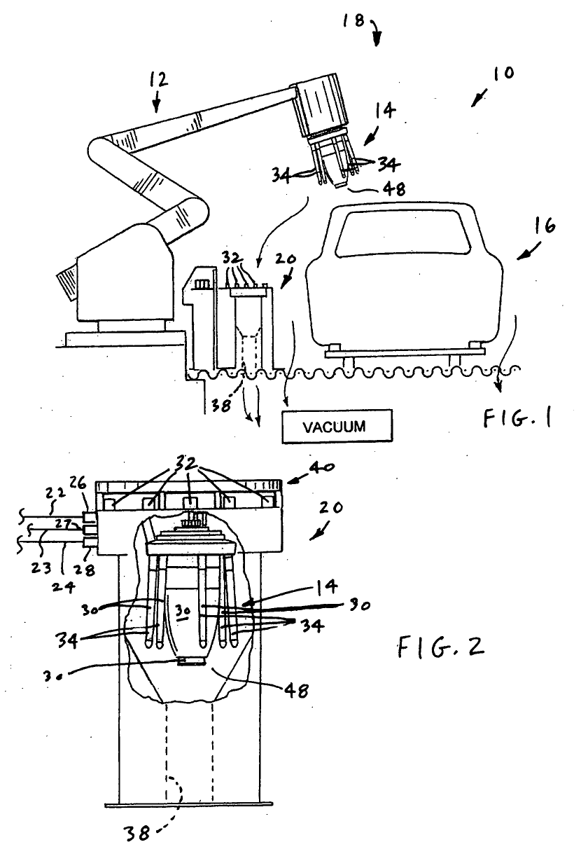

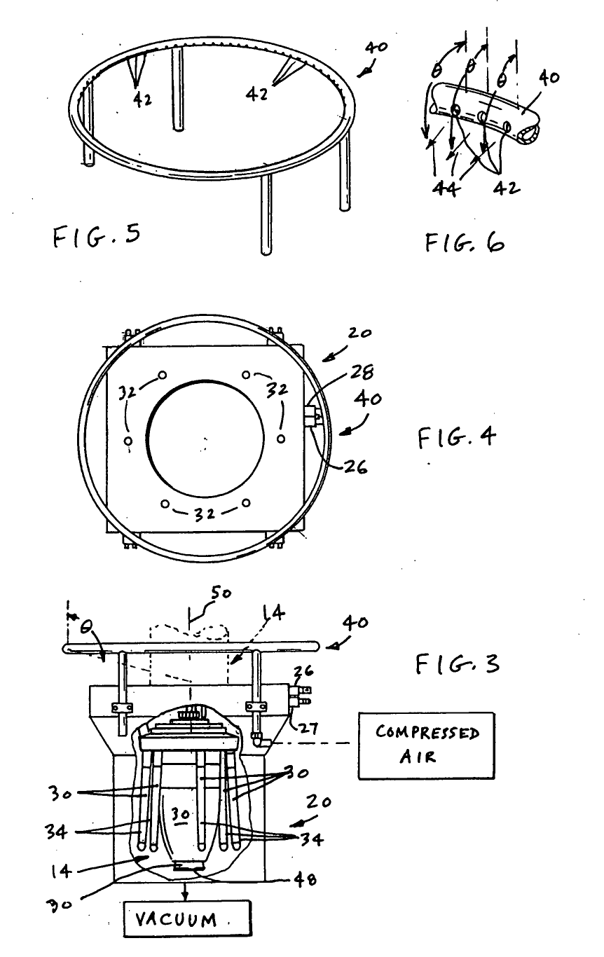

A coating dispensing station 10 includes a robot 12-mounted atomizer 14 for dispensing coating material onto targets 16 as the targets 16 are conveyed through a coating booth 18. A cleaning device 20 for cleaning the atomizer 14 is mounted in the booth 18. Cleaning device 20 may be, for example, of the type illustrated and described in the above identified 2006/0048803. Water, other solvent and compressed air lines 22, 23, 24, FIG. 2, respectively, are coupled to the cleaning device 20 as needed for proper operation. When the atomizer 14 is to be cleaned, the robot 12 moves the atomizer 14 into the cleaning device 20. A sequence of operations of water and/or other solvent and compressed air valves 26, 27, 28, respectively, is executed to clean the exterior surfaces 30 of the atomizer 14.

At the end of the cleaning cycle, as the atomizer 14 is withdrawn from the cleaning device 20, air nozzles 32 blow streams of air across the exterior surfaces 30 of the atomizer 14 to dry residual moisture. While prior art air nozzles were suited for blowing the housings of certain types of rotary atomizers dry, it has been found that prior art air nozzles often did not effectively dry exterior surfaces 30 of indirect charging atomizers 14, for example, ones of the general type illustrated and described in U.S. patents: U.S. Pat. Nos. 5,085,373; 4,955,960; 4,872,616; 4,852,810; 4,771,949; 4,760,965; 4,143,819; 4,114,810; 3,408,985; 3,952,951; 3,393,662; 2,960,273; and, 2,890,388. The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

As the above-identified patents illustrate, such indirect charging atomizers 14 typically have a few to several high voltage electrodes 34 mounted on the exterior 30 of the atomizer 14. This exterior mounting of the external charging electrodes 34 requires the air jets 32 and the vacuum port(s) 38 of the cleaning device 20 to be spaced more remotely to provide room in the cleaning device 20 to introduce into the cleaning device 20 at least a portion of the atomizer 14 to be cleaned. This more remote spacing of the air jets 32 and the vacuum port(s) 38 of the cleaning device 20 makes satisfactory drying of the exterior 30 of the atomizer 14, including the external charging electrodes 34, more difficult to achieve.

A ring 40 with nozzles or jets 42 is, for example, vertically adjustably mounted on cleaning device 20 in the areas and proximity required around the atomizer 14. The drying air distribution pattern achieved by ring 40 with jets 42 dries the atomizer 14 as the atomizer 14 is removed from the cleaning device 20. The jets or nozzles 42 are so positioned around the ring 40 that their air streams 44 overlap adjacent air streams 44, creating a wall or curtain of air, an air knife. This wall, curtain or knife is oriented so that the moisture being removed is pushed towards the front 48 of the atomizer 14, that is, the end 48 of the atomizer 14 from which atomized coating material is discharged during atomization, and thus into, and toward the vacuum port(s) 38 of, the cleaning device 20 where vacuum draws the moisture out to waste. This angle, θ, of the wall, curtain or knife can be, but is not, limited to 90° to the central axis 50 of the atomizer 14, that is, to a line 50 drawn from the center of the front 48 of the atomizer 14 rearward away from the front 48 of the atomizer 14. It is only required that 90°≦θ≦180°, preferably 90°<θ≦180°, in order for the moisture being removed to be pushed towards the front 48 of the atomizer 14, that is, the end 48 of the atomizer 14 from which atomized coating material is discharged during atomization, and thus toward the vacuum port(s) 38 of the cleaning device 20. Generally, the greater than 90° the angle θ is, the more effectively the liquid remaining on the outside surfaces of atomizer 14 is removed into the cleaning device 20. However, as θ increases beyond about 135°, the height of cleaning device 20 will generally have to increase to get the desired length of atomizer 14 into the device 20 so that the wall, curtain or knife of air can contact the necessary length of the atomizer 14 to remove the liquid remaining on it.

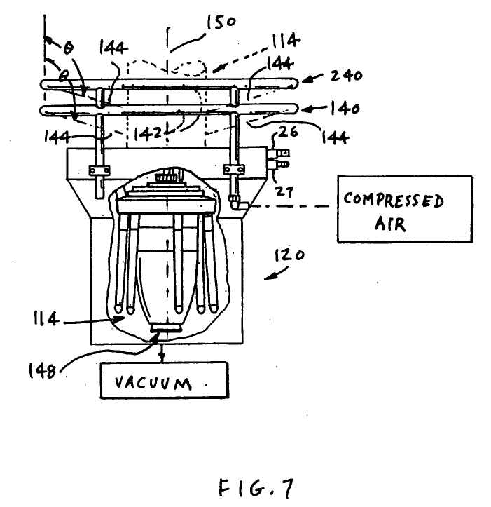

In a second embodiment illustrated in FIG. 7, two rings 140, 240 with nozzles or jets 142 are stacked at the opening through which atomizer 114 is inserted into, and removed from, cleaning device 120. The drying air distribution pattern achieved by rings 140, 240 with jets 142 dries the atomizer 114 as the atomizer 114 is removed from the cleaning device 120. The jets or nozzles 142 are so positioned around the rings 140, 240 that their air streams 144 overlap adjacent air streams 144 from the same ring 140, 240, creating a wall, curtain or knife of air. This wall, curtain or knife is oriented so that the moisture being removed is pushed towards the front 148 of the atomizer 114, that is, the end of the atomizer 114 from which atomized coating material is discharged during atomization, and thus into, and toward the vacuum port(s) of, the cleaning device 120 where vacuum draws the moisture out to waste. This angle, θ, of the wall, curtain or knife can be, but is not, limited to 90° to the central axis 150 of the atomizer 114, that is, to a line 150 drawn from the center of the front 148 of the atomizer 114 rearward away from the front 148 of the atomizer 114. It is only required that 90°≦θ≦180°, again, preferably 90°<θ≦180°, in order for the moisture being removed to be pushed towards the front 148 of the atomizer 114, that is, the end 148 of the atomizer 114 from which atomized coating material is discharged during atomization, and thus toward the vacuum port(s) of the cleaning device 120.

Nor are the jets 42, 142 restricted to being circular cross-section jets as might be obtained by creating the jets in the rings 40, 140, 240 by drilling them. For example, in the ring 340 illustrated in FIGS. 8-9, a substantially continuous jet 342 in the form of a slot is provided around the inner perimeter of the ring 340. Again, the angle, θ, of the wall, curtain or knife can be, but is not, limited to 90° to the central axis 350 of the atomizer, that is, to a line 350 drawn from the center of the front of the atomizer rearward away from the front of the atomizer. It is only required that 90°≦θ≦180°, again, preferably 90°<θ≦180°, in order for the moisture being removed to be pushed towards the front of the atomizer, that is, the end of the atomizer from which atomized coating material is discharged during atomization, and thus toward the vacuum port(s) of the cleaning device.

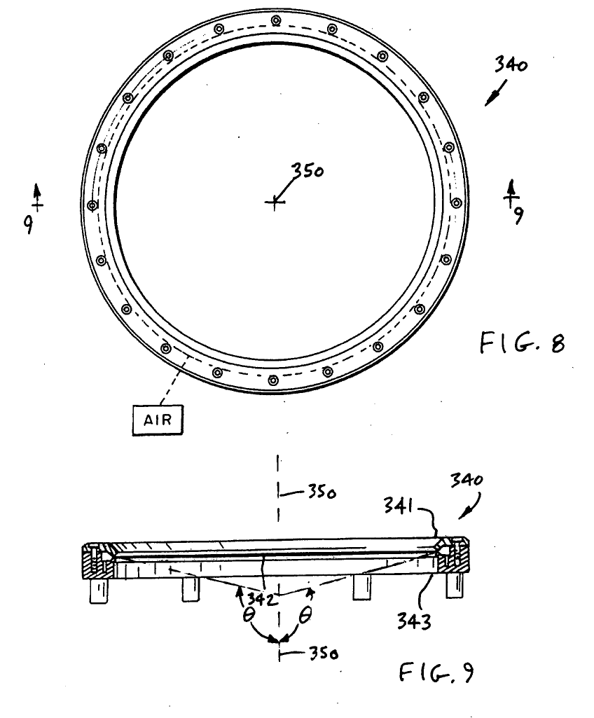

Other structures for the ring and nozzles are illustrated in FIGS. 10-12 and 13-15, respectively. In the embodiment illustrated in FIGS. 10-12, several, illustratively six, nozzles 432 are oriented, illustratively equally spaced, about a ring 440 to which compressed air or other suitable drying gas is supplied. Each nozzle 432 includes vertically extending, horizontally spaced fins 442 distributing the flow of the drying gas from nozzle 432. The conduits 444 which couple the nozzles 432 to the ring 440 permit orienting the nozzles 432 at (a) desired angle(s) θ to a line drawn from the center of the front of an atomizer, for example, by incorporating ball joints 445 to permit such adjustment as illustrated in FIG. 12. Again, the angle, θ, of the wall, curtain or knife can be, but is not, limited to 90° to the central axis of the atomizer. It is only required that 90°≦θ≦180°, again, preferably 90°<θ≦180°, in order for the moisture being removed to be pushed towards the front of the atomizer, that is, the end of the atomizer from which atomized coating material is discharged during atomization, and thus toward the vacuum port(s) of the cleaning device.

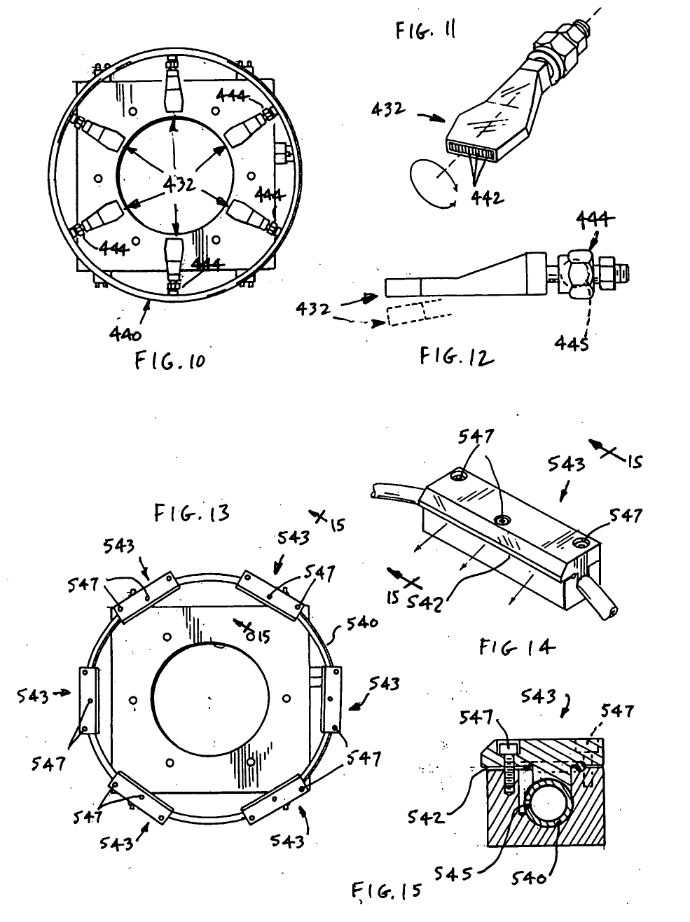

In the embodiment illustrated in FIGS. 13-15, the blowoff fixture is similar to the embodiment illustrated in FIGS. 8 and 9 except that the slot of FIGS. 8 and 9 is divided up into multiple shorter length slots 542 in the embodiment illustrated in FIGS. 13-15. The slots 542 are provided by separate slot-forming devices 543 mounted is spaced-apart relation around a tubular ring 540. At the location of each slot-forming device 543, the sidewall of the ring 540 is provided with a suitable number of circular cross section, slot-shaped, or other suitably shaped openings 545 to ensure adequate flow to its respective slot 542. Again, the angle, θ, of the wall, curtain or knife can be, but is not, limited to 90° to the central axis of the atomizer, that is, to a line drawn from the center of the front of the atomizer rearward away from the front of the atomizer. It is only required that 90°≦θ≦180°, again, preferably 90°<θ≦180°, in order for the moisture being removed to be pushed towards the front of the atomizer, that is, the end of the atomizer from which atomized coating material is discharged during atomization, and thus toward the vacuum port(s) of the cleaning device. An advantage of the embodiment illustrated in FIGS. 13-15 over that illustrated in FIGS. 8-9 is that in the embodiment illustrated in FIGS. 8-9, the angle θ is established during the fabrication of the two rings 341, 343 between which the slot(s) 342 is (are) defined. In the embodiment illustrated in FIGS. 13-15, on the other hand, each slot forming device 543 can be unclamped from the ring 540 by loosening screws 547, reorienting the slot forming device 543 on the ring 540, and then retightening the screws 547.

What is claimed is:

1. Apparatus for cleaning an atomizer, the apparatus comprising a cleaning device including an opening sized to receive at least a portion of the atomizer, the cleaning device including a solvent coupling for supplying solvent to wash an exterior surface of the atomizer and an opening through which waste solvent is discharged, a first conduit formed in a first closed curve around the opening, the first conduit including a first sidewall, a supply of drying gas or mixture of gases coupled to the first conduit, at least a first passageway through the first sidewall, an outer end of each first passageway directing a first flow of drying gas or mixture of gases onto the exterior surface of the atomizer to dry the exterior surface of the atomizer as the atomizer is withdrawn from the opening.

2. The apparatus of claim 1 wherein the first passageways are so oriented that adjacent first flows overlap or intersect each other to form a first curtain of drying gas or mixture of gases.

3. The apparatus of claim 1 wherein the first flows make angles θ with lines drawn from a front of the atomizer, 90°≦θ≦180°.

4. The apparatus of claim 3 wherein the first passageways comprise at least one first slot, long dimensions of the at least one first slot extending generally along the first closed curve.

5. The apparatus of claim 3 wherein the first passageways have first circular cross sections, the axes of the first passageways making the angles θ.

6. The apparatus of claim 1 further including a second conduit formed in a second closed curve around the opening, the second conduit including a second sidewall, a supply of drying gas or mixture of gases coupled to the second conduit, at least one second passageway through the second sidewall, an outer end of each second passageway directing a second flow of drying gas or mixture of gases onto the exterior surface of the atomizer to dry the exterior surface of the atomizer as the atomizer is withdrawn from the opening.

7. The apparatus of claim 6 wherein the second flows of drying gas or mixture of gases make angles φ with lines drawn from a front of the atomizer, 90°≦φ≦180°.

8. The apparatus of claim 7 wherein the second passageways comprise at least one second slot, the long dimension of the at least one second slot extending generally along the second closed curve.

9. The apparatus of claim 7 wherein the second passageways have second circular cross sections, the axes of the second passageways making the angles φ.

10. The apparatus of claim 1 further including a robot for manipulating the atomizer into and from the opening.

12. The apparatus of claim 1 further including a coating booth in which the coating is dispensed, wherein the cleaning device is located inside the coating booth.

13. The apparatus of claim 12 wherein the cleaning device is coupled to the coating booth floor, the coating booth floor providing vacuum to the opening.
